(19) United States
(12) Patent Application Publication
(10) Pub. No.: US 2008/0140758 A1
(43) Pub. Date: Jun. 12, 2008

(54) SYSTEM AND METHOD FOR FILLING A FORM OF A WEB PAGE

(75) Inventors: CHUNG-I LEE, Tu-Cheng (TW); HAI-HONG LIN, Shenzhen (CN); DE-YI XIE, Shenzhen (CN); ZHENG-CAI ZHU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/831,966

(22) Filed: Aug. 1, 2007

(30) Foreign Application Priority Data
Dec. 6, 2006 (CN) 200610157341.5

(51) Int. Cl. G06F 15/16

(52) U.S. Cl. 709/201

(57) ABSTRACT

A method for filling a form of a web page stored in a Web server (1) includes the steps of: providing an application server (2) for receiving parameter values; searching and obtaining to-be-posted new data from a database (3) according to the parameter values; matching the to-be-posted new data with one or more corresponding input fields of the form of the Web page according to the parameter values; accessing the Web page of the Web server; filling up the corresponding input fields with the to-be-posted new data; and activating the form of the Web page in order to post data of the corresponding input fields to the Web server. A related system is also provided.

### BACKGROUND OF THE INVENTION

1. Field of the Invention

The present invention generally relates to systems and methods for managing a Web page, and more particularly to a system and method for filling a form of a web page.

2. Description of Related Art

In a computer network environment, Web servers always respond to users' Web page requests, which are transmitted through the computer network. Web page requests, also referred to as content requests, typically are made by a browser running on a computer. A Web server monitors one or more computer network address/port terminals for Web page requests and responds to the Web page requests by transmitting Web pages to computers that sent the request.

It is well known that the Web page needs to be updated with new data when content of the Web page are outdated. However, the users need to fill up input fields of a form of the Web page with the new data through a manual work.

What is needed, therefore, is a system and method for filling a form of a web page, so as to avoid a manual work for filling the form of the web page, and further to avoid manual errors while the form of the web page is filled.

### SUMMARY OF THE INVENTION

A system for filling a form of a web page stored in a Web server in accordance with a preferred embodiment includes a database, and an application server connected with the Web server and the database. The database is for storing data which are to be posted on the Web server. The application server includes a receiver, an obtaining module, and a loading module. The receiver is configured for receiving parameter values. The obtaining module is configured for searching and obtaining to-be-posted new data from the database according to the parameter values. The loading module is configured for matching the to-be-posted new data with one or more corresponding input fields of the form of the Web page according to the parameter values, for accessing the Web page, for filling up the corresponding input fields with the to-be-posted new data, and for activating the form of the Web page in order to post data of the corresponding input fields to the Web server.

A computerized method for filling a form of a web page stored in a Web server in accordance with a preferred embodiment includes the steps of: providing an application server for receiving parameter values; searching and obtaining to-be-posted new data from a database according to the parameter values; matching the to-be-posted new data with one or more corresponding input fields of the form of the Web page according to the parameter values; accessing the Web page of the Web server; filling up the corresponding input fields with the to-be-posted new data; and activating the form of the Web page in order to post data of the corresponding input fields to the Web server.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of a hardware configuration of a system for filling a form of a web page in accordance with a preferred embodiment;

FIG. 2 is a schematic diagram of main function modules of an application server of the system of FIG. 1; and

FIG. 3 is a flowchart of a method for filling a form of a web page in accordance with a preferred embodiment.

### DETAILED DESCRIPTION OF THE INVENTION

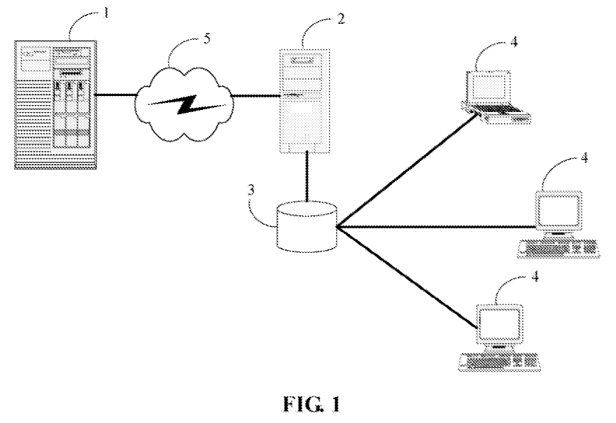

FIG. 1 is a schematic diagram of a hardware configuration of a system for filling a form of a web page (hereinafter, “the system”) in accordance with a preferred embodiment. The system typically includes a Web server 1, an application server 2 that connects with the Web server 1 via a network 5, one or more client computers 4 (only three shown), and a database 3 that connects with the application server 2 and the client computers 4. The network 5 can be an intranet, the Internet, or any other suitable type of communications link. The Web server 1 is for storing the Web page. The client computers 4 are for collecting various data such as product performance data and product price data, and for transmitting collected data to the database 3. The application server 2 is configured for accessing the Web page via the network 5, for searching and obtaining to-be-posted new data from the database 3, and for filling up input fields of the form of the Web page with the to-be-posted new data. The to-be-posted new data are to be posted on the Web server 1. The input fields of the form may include a text box, a check box, a radio button, and a select box.

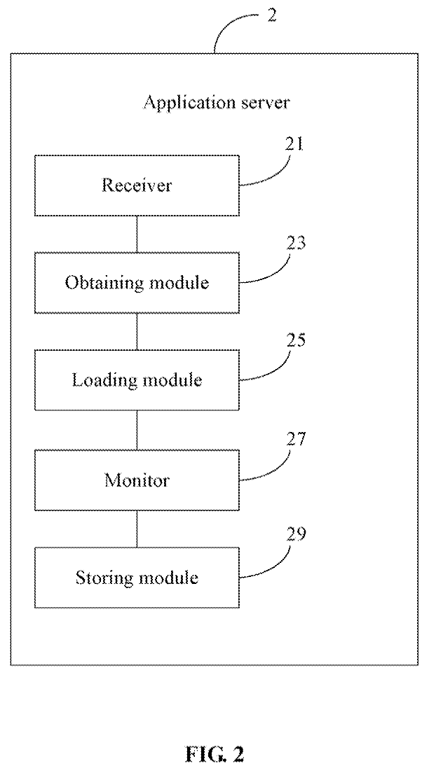

FIG. 2 is a schematic diagram of main function modules of the application server 2 of FIG. 1. The application server 2 may include a receiver 21, an obtaining module 23 linked with the receiver 21, a loading module 25 linked with the obtaining module 23, a monitor 27 linked with the loading module 25, and a storing module 29 linked with the monitor 27.

The receiver 21 is configured for outputting a user interface for receiving parameter values. The parameter values may be predefined by a user via an input device (e.g., a key board). The parameter values may include keywords related to the to-be-posted new data, mappings between the keywords and the input fields of the form of the Web page. For example, one of the keywords can be predefined with “applicant=A” if the to-be-posted new data include patent data of a company named “A”. The keyword “applicant=A” relates to a corresponding input field that are used for receiving the patent data of the company “A”. A mapping between the keyword “applicant=A” and the corresponding input field is predefined.

The obtaining module 23 is configured for searching and obtaining the to-be-posted new data from the database 3 according to the keywords of the parameter values.

The loading module 25 is configured for matching the to-be-posted new data with one or more corresponding input fields of the form of the Web page according to the mappings, and for accessing the Web page via the network 5. Furthermore, the loading module 25 is configured for filling up the corresponding input fields with the to-be-posted new data. In addition, the loading module 25 is configured for activating a submit button of the form of the Web page, in order to post data of the corresponding input fields to the Web server 1.

The monitor 27 is configured for monitoring data transmitted from the Web server 1 to the application server 2. The data transmitted from the Web server 1 to the application server 2 may include a message that indicates whether the obtained data on the form of the Web page is successfully posted, and a uniform resource locator (URL) address of the Web page.

The storing module 29 is configured for storing the data monitored by the monitor 27.

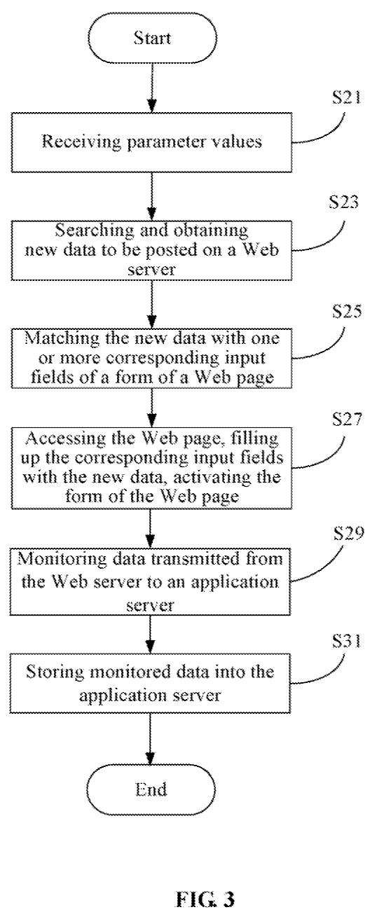

FIG. 3 is a flowchart of a method for filling a form of a web page in accordance with a preferred embodiment. In the preferred embodiment, the application server 2 is used to fill the form of the web page that is stored in the Web server 1. In step S21, the receiver 21 outputs a user interface for receiving the parameter values. The parameter values include the keywords related with the to-be-posted new data, the mappings between the keywords and the input fields of the form of the Web page.

In step S23, the obtaining module 23 searches and obtains the to-be-posted new data from the database 3 according to the keywords of the parameter values.

In step S25, the loading module 25 matches the to-be-posted new data with one or more corresponding input fields of the form of the Web page according to the mappings of the parameter values.

In step S27, the loading module 25 accesses the Web page via the network 5, fills up the corresponding input fields with the to-be-posted new data, and activates the submit button of the form of the Web page, in order to post data of the corresponding input fields to the Web server 1.

In step S29, the monitor 27 monitors the data transmitted from the Web server 1 to the application server 2. The data transmitted from the Web server 1 to the application server 2 include the message that indicates whether the obtained data on the form of the Web page is successfully posted, and a uniform resource locator (URL) address of the Web page.

In step S31, the storing module 29 stores the data monitored by the monitor 27.

It should be emphasized that the above-described embodiments of the preferred embodiments, particularly, any “preferred” embodiments, are merely possible examples of implementations, and set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s), and protected by the following claims.

What is claimed is:

1. A system for filling a form of a web page stored in a Web server, the system comprising:
a database for storing data which are to be posted on the Web server; and
an application server connected with the Web server and the database, the application server comprising:
a receiver configured for receiving parameter values;
an obtaining module configured for searching and obtaining to-be-posted new data from the database according to the parameter values; and
a loading module configured for matching the to-be-posted new data with one or more corresponding input fields of the form of the Web page according to the parameter values, for accessing the Web page, for filling up the corresponding input fields with the to-be-posted new data, and for activating the form of the Web page in order to post data of the corresponding input fields on the Web server.

2. The system as claimed in claim 1, wherein the application server further comprises a monitor configured for monitoring data transmitted from the Web server to the application server.

3. The system as claimed in claim 1, wherein the application server further comprises a storing module configured for storing the data monitored by the monitor.

4. The system as claimed in claim 1, further comprising one or more client computers connected with the database, the client computers being configured for collecting the data to be posted on the Web server, and for transmitting collected data to the database.

5. The system as claimed in claim 1, wherein the parameter values comprise keywords related to the to-be-posted new data, mappings between the keywords and input fields of the form of the Web page.

6. A computerized method for filling a form of a web page stored in a Web server, the method comprising the steps of:
providing an application server for receiving parameter values; searching and obtaining to-be-posted new data from a database according to the parameter values;
matching the to-be-posted new data with one or more corresponding input fields of the form of the Web page according to the parameter values;
accessing the Web page of the Web server;
filling up the corresponding input fields with the to-be-posted new data; and activating the form of the Web page in order to post data of the corresponding input fields to the Web server.

7. The method as claimed in claim 6, further comprising the steps of: monitoring data transmitted from the Web server to the application server; and storing the monitored data.

8. The method as claimed in claim 6, further comprising the step of: providing one or more client computers for collecting data to be posted on the Web server, and for transmitting collected data to the database.

9. The method as claimed in claim 8, wherein the parameter values comprise keywords related to the to-be-posted new data, mappings between the keywords and input fields of the form of the Web page.
